(19) United States
(12) Patent Application Publication
(10) Pub. No.: US 2013/0229530 A1
(43) Pub. Date: Sep. 5, 2013

(54) SPECTRAL CALIBRATION OF IMAGING DEVICES

(71) Applicants: Paul M. Hubel, Mountain View, CA (US); Richard L. Baer, Los Altos, CA (US)

(72) Inventors: Paul M. Hubel, Mountain View, CA (US); Richard L. Baer, Los Altos, CA (US)

(73) Assignee: Apple Inc., Cupertino, CA (US)

(21) Appl. No.: 13/410,595

(22) Filed: Mar. 2, 2012

(51) Int. Cl. H04N 17/02; H04N 5/76

(52) U.S. Cl. 348/187; 348/231.6; 348/E17.004; 348/E05.024

(57) ABSTRACT

Determining, applying and storing model spectral response parameters used to correct colors in a digital image. The model spectral response parameters may be estimated through a recursive error analysis and applied or stored to all digital imaging devices of a particular type, thereby occupying minimal firmware storage space and permitting on the fly correction of images.

### TECHNICAL FIELD

This application relates generally to imaging devices, and more particularly to calibrating the spectral response of an imaging device.

### BACKGROUND

Digital imaging devices, such as cameras and video cameras, are increasingly common in modern society. They not only stand alone but have been incorporated into many electronic devices, including computers, mobile phones, tablet computing devices, and so on. Every digital imaging device has slight variances in color for a captured image when compared to every other digital imaging device.

Generally, it may be desirable for a digital imaging device to capture and generate an image having a particular color profile. Difference in color reproduction across different products are generally due to image processing. Color response variations may be significantly affected by the automatic white balance algorithm or methodology employed by a particular digital imaging device, for example. In some cases, certain digital imaging devices may fail to correctly balance neutral colors in captured images when exposed to certain illuminants, while other devices that are seemingly identical may perform as expected.

Further, in many cases users do not always desire accurate color reproduction in digitally captured images. For example, in some images exaggerated color may be desired. In order to properly produce the colors desired by a user, those colors must be initially accurately represented by the color response of the digital imaging device. It may be useful, then, to determine a spectral response of a given digital imaging device.

Directly measuring a device's spectral response may be relatively tedious and lengthy since a separate measurement generally would be required for each wavelength. Further, specialized (and expensive) test equipment such as monochrometers and power meters may be required. Thus, direct measurement may be impractical in many production scenarios.

Further, even if direct measurement of a device's spectral response were practical, the resulting data would be fairly large and might overflow the non-volatile memory of the imaging device, or occupy an excessive portion of the memory. Accordingly, what is needed is a rapid measurement procedure that can be performed with relatively inexpensive equipment, resulting in a compact representation of a spectral response.

### SUMMARY

Generally, embodiments described herein may take the form of devices and methods for calibrating the spectral response of an imaging device. One embodiment may take the form of a method for determining color correction parameters for a digital imaging device, comprising the operations of: estimating a set of model parameters; determining a spectral response corresponding to the set of model parameters; determining a set of estimated color ratios corresponding to the set of model parameters; calculating an error of the set of estimated color ratios with respect to a set of measured color ratios; and in the event the error is below a threshold, storing the set of model parameters in the digital imaging device.

Another embodiment may take the form of a method for creating a digital image, comprising the operations of: capturing, by a digital imaging device, a digital image; retrieving a set of model parameters from a storage medium of the digital imaging device; creating a color correction matrix from the set of model parameters; and applying the color correction matrix to the digital image, thereby generating a color-corrected digital image.

Still another embodiment may take the form of a digital imaging device, comprising: a lens; a digital imaging sensor in optical communication with the lens; an infrared filter positioned between the lens and digital imaging sensor, such that light passing through the lens and impinging upon the sensor passes through the infrared filter; one or more color filters adjacent the digital imaging sensor; a processor operative to receive digital imaging data captured by the digital imaging sensor; and a storage medium in communication with the processor and operative to store a set of model parameters; wherein the processor is operative to retrieve the set of model parameters, construct a color correction matrix from the model parameters, and employ the color correction matrix to adjust the digital imaging data.

Embodiments disclosed here may, for example, determine a spectral response of camera digital imaging device in an efficient manner, then record that spectral response (or parameters that may be used to create a representation of that response) in a memory of a digital imaging device.

Other embodiments and advantages will be apparent upon reading the detailed description.

### BRIEF DESCRIPTION OF THE FIGURES

FIG. 1A is a front perspective view of an example embodiment of a digital imaging device.

FIG. 1B is a rear perspective view of the imaging device of FIG. 1.

FIG. 2A is a front perspective view of another embodiment of an imaging device.

FIG. 2B is a rear perspective of the embodiment of imaging device of FIG. 2A.

FIG. 3 is a cross-sectional view the imaging device shown in FIG. 1A, taken along line 3-3 of FIG. 1A.

FIG. 4 is a block diagram illustrating select components of a sampleimaging device.

FIG. 5 is a flowchart generally depicting a sample method for determining a set of model parameters that may be used to calibrate a spectral response of a digital imaging device.

FIG. 6 is a graph showing a relationship between a wavelength of an illuminant and a cutoff characteristic of an infrared filter.

### DETAILED DESCRIPTION

Generally, embodiments described herein may take the form of devices and methods for calibrating, and thus improving, the spectral response of an imaging device.

It should be appreciated that the spectral response of an imaging device, such as a digital camera module, varies between devices. This is true even between different iterations of the same device. Two imaging devices constructed identically and at substantially the same time may have varying spectral responses, for example. Variances in spectral response may cause imaging devices to be more or less sensitive to certain wavelengths of light, and thus cause each imaging device to capture and produce an image that has slightly shifted colors, whether relative to one another or the imaged scene. Accordingly, it is useful to compensate for the variations in the spectral responses of multiple instances of the same type of imaging device (such as different physical cameras that are of the same make and model); this adjustment or compensation may be made by using a color correction matrix.

In order to capture and produce consistent images, each imaging device must be corrected to account for certain physical characteristics that may vary between devices. It should be appreciated that two image attributes may need correction to account for these variances. First, the neutral balance (e.g., white balance) of the imaging device may be adjusted by embodiments described herein. Generally, neutral colors in a scene should appear neutral in the image capturing the scene. Neutral colors, such as various shades of gray and white, may appear tinted by shades of non-neutral colors in a raw image. Neutral balancing is essentially the operation of adjusting the image to remove such tints, thereby rendering achromatic colors accurately in a final image. As one example, a diagonal matrix may be used to scale the raw primary color channels of each pixel in an image to achieve a color balanced image. “Primary color channels,” as used herein, generally refer to the red, green and blue color channels of an image, as captured by an image sensor.

In addition, embodiments described herein may create and apply a color correction matrix to transform primary colors, as captured by the imaging device. This may be useful, for example, to match the color in an image captured by the imaging device to a color in a scene being captured. In some embodiments, a 3×3 matrix may be used to correct the primary color channels. Other embodiments may employ a matrix having a different number of rows and/or columns. Given the methods disclosed herein, a matrix of any arbitrary or desired size (e.g., N×N) may be created and used for digital image correction and/or spectral calibration of a digital imaging device. Still another implementation for performing color correction may take the form of a two- or three-dimensional look-up table. Embodiments described herein provide a simplified method for generating a color correction matrix that may be used in image color correction.

As used herein, the term “scene” refers to the area, object, or other physical configuration that is represented in an image captured by the imaging device. Thus, an image represents a scene.

The Imaging Device

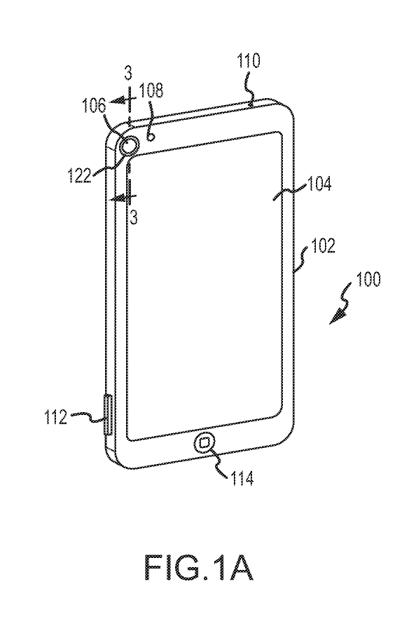

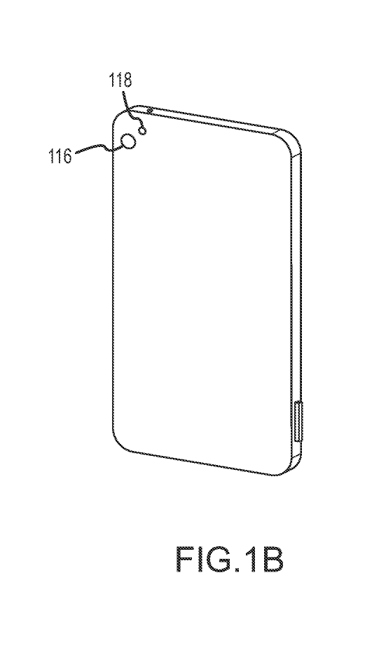

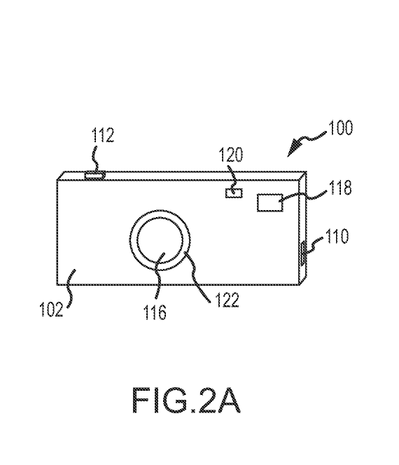

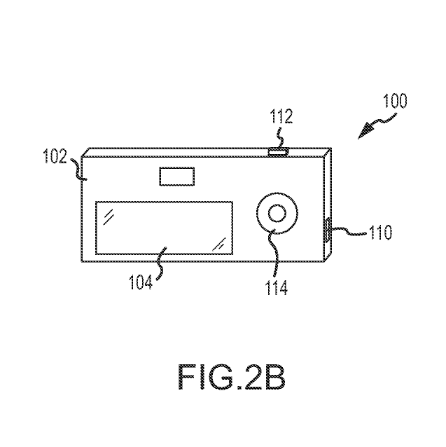

The methods and devices described herein can be used with substantially any type of apparatus or device that may capture an image. FIG. 1A is a front perspective view of an example embodiment of an imaging device 100. FIG. 1B is a rear perspective view of the imaging device 100. As shown in FIGS. 1A and 1B, in some instances the imaging device 100 may be a mobile electronic device, such as, but not limited to, a smart phone, a digital camera, digital music player, cellular phone, gaming device, tablet computer, notebook computer and so on. In these instances, the mobile electronic device may have an incorporated camera or image sensing device so as to function as the imaging device. However, in other embodiments, the imaging device may be a stand-alone camera or a camera otherwise incorporated into another type of device. FIG. 2A is a front perspective view of another embodiment of the imaging device 100. FIG. 2B is a rear perspective of the embodiment of imaging device 100 of FIG. 2A.

Referring to FIGS. 1A-2B, the imaging device 100 may include an enclosure 102, a display 104, a camera 106, a light source 108, an output port 110, and one or more input mechanisms 112, 114. The enclosure 102 may at least partially surround components of the imaging device 100 and form a housing for those components.

The display 104 provides an output for the imaging device 100. For example, the display 104 may be a liquid crystal display, plasma display, a light emitting diode (LED) display, or so on. The display 104 may display images captured by the imaging device, may function as a viewfinder and display images that may be within a field of view of the imaging device. Furthermore, the display 104 may also display outputs of the imaging device 100, such as a graphical user interface, application interfaces, and so on.

The display 104 may also function as an input device in addition to displaying output from the imaging device 100. For example, the display 104 may include capacitive touch sensors, infrared touch sensors, or the like that may track a user's touch on the display 104. In these embodiments, a user may press on the display 104 in order to provide input to the imaging device 100.

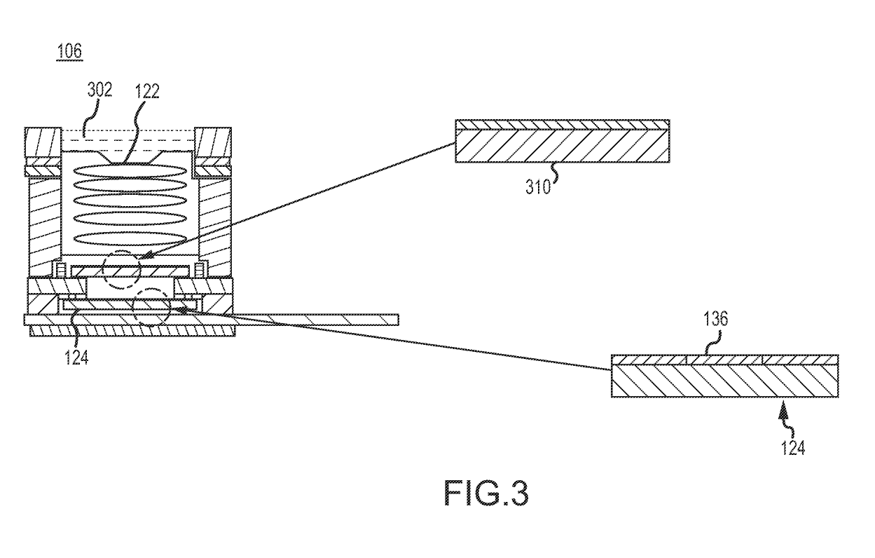

The imaging device 100 may also include one or more cameras 106, 116. The cameras 106, 116 may be positioned substantially anywhere on the imaging device 100; and there may be one or more cameras 106, 116 on each device 100. The cameras 106, 116 capture light from an image. FIG. 3 is a cross-sectional view of a first camera 106 in FIG. 1A, taken along line 3-3 in FIG. 1A. However, it should be noted that the cameras 106, 116 may be substantially similar to each other. That said, with reference to FIG. 3, each camera 106, 116 may include some or all of the elements shown in FIG. 3.

Generally, and as shown in the partial cross-sectional view of FIG. 3, the imaging device 106 includes a lens 122 in optical communication with an aperture 302. The lens 122 may move between a variety of physical positions to focus the camera, as shown. The opening 302 may be covered or filled with an optically transparent material 304, such as glass, crystal or a polymer. Any such optically transparent material 304, or the lens 122, may include or have an optical coating, examples of which include an anti-reflective coating or an infrared filter. Such coatings may be modeled according to the embodiments described here. Light may enter the aperture 302, impact the lens 122 and be focused on the surface of an image sensor 124. The image sensor 124 may capture an image of a scene at which the imaging device 106 is directed. It should be appreciated that the view shown in FIG. 3 may omit certain elements to clearly show the lens, filter and sensor structure.

Light focused by the lens 122 may pass through an infrared filter 310 and a color filter array 136 before impacting the sensor 124. The color filter array 136 may filter incident light such that only certain wavelengths of light impact the sensor 124. The color filter array 136 may be subdivided into multiple color sub-filters, such as red, green and blue sub-filters. Each may filter light, letting only corresponding wavelengths through and onto the portion of the sensor 124 located beneath each such sub-filter. Thus, different portions of the sensor 124 may receive and record different wavelengths of light. As one example, the color filter array 136 may be a Bayer array.

The lens 122 may be substantially any type of optical device that may transmit and/or refract light. In one example, the lens 122 is in optical communication with the sensor 124, such that the lens 122 may passively transmit light from a field of view to the sensor 124. The lens 122 may include a single optical element or may be a compound lens and include an array of multiple optical elements. In some examples, the lens 122 may be glass or transparent plastic; however, other materials are also possible. The lens 122 may additionally include a curved surface, and may be a convex, bio-convex, plano-convex, concave, bio-concave, and the like. The type of material of the lens as well as the curvature of the lens 122 may be dependent on the desired applications of the system 122. Furthermore, it should be noted that the lens 122 may be stationary within the imaging device 100, or the lens 122 may selectively extend, move and/or rotate within the imaging device 100. As one example, the lens may move toward or away from the image sensor 124 and/or aperture 302.

The image sensor 124 may be substantially any type of sensor that may capture an image or sense a light pattern. The sensor 124 may be able to capture visible, non-visible, infrared and other wavelengths of light. The sensor 124 may be an image sensor that converts an optical image into an electronic signal. For example, the sensor 124 may be a charged coupled device, complementary metal-oxide-semiconductor (CMOS) sensor, or photographic film. The sensor 124 may be in optical communication or electrical communication with a filter that may filter select light wavelengths, or the sensor 124 may be configured to filter select wavelengths, (e.g., the sensor may include photodiodes only sensitive to certain wavelengths of light).

A substrate may be adjacent to the sensor 124. In some embodiments, the sensor 124 may be formed on the substrate. The substrate may route electrical signals and/or power to or from the portion of the imaging device shown in FIG. 3. As one example, the substrate may transmit image data from the sensor 124 to a processor and/or data storage, neither of which are shown for simplicity's sake. Likewise, the substrate may route power to various elements of the imaging device. The substrate may be, for example, a printed circuit board or flex member.

The processor 130 may control operation of the imaging device 100 and its various components. The processor 130 may be in communication with the display 104, the communication mechanism 128, the memory 134, and may activate and/or receive input from the image sensor 124 as necessary or desired. The processor 130 may be any electronic device cable of processing, receiving, and/or transmitting instructions. For example, the processor 130 may be a microprocessor or a microcomputer. Furthermore, the processor 130 may also adjust settings on the image sensor 124, adjust an output of the captured image on the display 104, may adjust a timing signal of the light source 108, 118, analyze images, and so on.

Spectral Response of the Imaging Device

For any given imaging device, a relatively small number of physical elements influence its spectral response. Generally, each of these elements have different filtering properties. The filtering properties include the transmissivity of the lens, the wavelength cutoff of the infrared interference filter, the thickness of the infrared absorptive filter, the thickness of the color filter array (“CFA”), and the wave filtering characteristics of the sensor itself. Mathematically expressed, the spectral response Ri for a given wavelength λ is as follows:

Ri(λ)=L(λ)·F1(λc,λ)·F2(Tir,λ)·Ci(Ti,λ)·S(λ) Eq. 1:

In this equation, L(λ) is the lens transmissivity at wavelength λ; F1(λc,λ) is the transmission characteristic of the IR interference filter as a function of a cutoff wavelength λc and wavelength λ F2(T,λ) is the transmission characteristic of the IR absorptive filter as a function of its thickness Tir and a given wavelength λ; Ci(Ti,λ) is the transmission characteristic of the color filter array as a function of thickness Ti and the wavelength λ for each of red, green and blue (e.g., “i” may be red, green or blue); and S(λ) is the responsivity of the sensor at wavelength λ. It should be appreciated that “transmissivity” and “transmission characteristic” are generally interchangeable; both refer to the fraction of incident light at a specified wavelength that passes through an object. Here, the specified wavelength is λ. It should be appreciated that certain embodiments may define any of the foregoing functions (L, F1, F2, Ci, S) solely as a function of wavelength λ. The thickness and/or absorptive function of each associated material (lens, filters, and the like) may be used to calculate the functions.

Thus, it can be seen that the lens has a certain transmissivity that generally depends on wavelength. As another example, the IR interference filter (F1 in the equation, above) has a transmissivity that varies not only by wavelength, but also by cutoff wavelength. That is, wavelengths over a certain frequency Inc will be completely prevented from passing through the interference filter; wavelengths below that filter nonetheless may be affected by the transmission characteristic of the IR interference filter. In some embodiments, Inc is approximately 650-660 nanometers. The remaining terms likewise define the transmissivity of the other imaging module elements.

The spectral response for any given imaging module may be determined once all five filter responses are known. The filter response functions may be described by a set of equations having certain parameters. In many cases, these parameters of these filter response functions may be empirically determined. For example, IR filter response curves typically may be obtained from the manufacturer of the IR filter. This is true for both the IR interference filter and the IR absorptive filter.

Response curves for each filter of the color filter array also may be determined empirically. That is, each of the red, green and blue response curves may be estimated by measuring the transmission of the material used to create the filters. Typically, such material is spun or otherwise deposited onto glass wafers to facilitate measurement. Once deposited onto the glass, the response curves of the CFA material may be measured empirically, for example with a monochrometer. There are generally different CFA response curves for each color of the color filter (e.g., red, green or blue). Further, the CFA response curves typically vary with the thickness of the filter layer. That is, the filter responses will vary exponentially with filter thickness. Thus, once a baseline response curve is determined, the baseline curve may be used to calculate or estimate the response curve for any given thickness of the color filter array. Generally, it may be assumed that, for any given chemical composition of the color filter array, the response curve is invariant for any given thickness. The chemical composition may determine the absorption of a color, IR or other filter; so long as the chemical composition remains consistent, the absorption characteristic of the filter will remain constant. The absorption characteristic, along with the thickness of any given filter, determines the response curve. Accordingly, the transmissivity of a color filter array having a known response curve varies principally according to one parameter, namely thickness of the array.

Referring back to Equation 1, above, it should be appreciated that the majority of variability between imaging devices is due to five spectral response parameters, namely: the IR interference cutoff filter wavelength (λc) (and optionally a cutoff slope (Sc)); the thickness of the IR absorptive filter (Tir); the thickness of the red color filter (Tr); the thickness of the blue color filter (Tb); and the thickness of the green color filter (Tg). Accordingly, if the various thicknesses and the cutoff wavelength Inc can be estimated, the spectral response of the imaging device may be relatively easily determined. Thus, these five parameters, along with the optional sixth parameter, form a compact representation of the imaging device's spectral response. Accordingly, the spectral response parameters may be stored in a non-volatile memory of the imaging device and used to create a color correction matrix that may be applied to captured images for neutral balancing and/or color balancing, as previously discussed. These parameters may also be used to create a neutral balance matrix in substantially the same fashion as creating a color correction matrix. It should be appreciated that the spectral response parameters may require substantially less memory or storage space than the corresponding color correction matrix. Thus, where storage is at a premium, storing the parameters may be particularly efficient.

It should be appreciated that the actual thickness of a color filter or absorptive filter need not be known to create an appropriate color correction matrix. Rather, all that is necessary is to determine a spectral response curve for a filter having an arbitrary thickness T. The spectral response curve may be manipulated to achieve a desired curve by scaling the arbitrary thickness. For example, doubling the arbitrary thickness T will square the corresponding spectral response curve for either a color filter or absorption filter. Thus, embodiments may employ a scaling factor for thickness (e.g., a multiple of thickness either greater than, equal to, or less than 1.0) for the various thickness-dependent spectral response parameters rather than absolute values or measurements of thickness.

Method for Determining Spectral Response Parameters

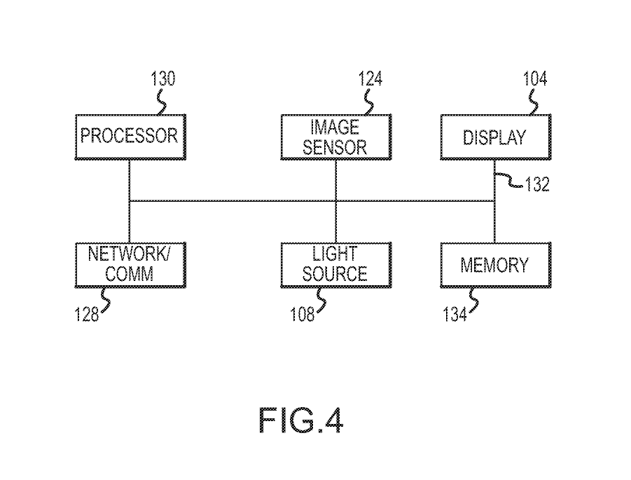

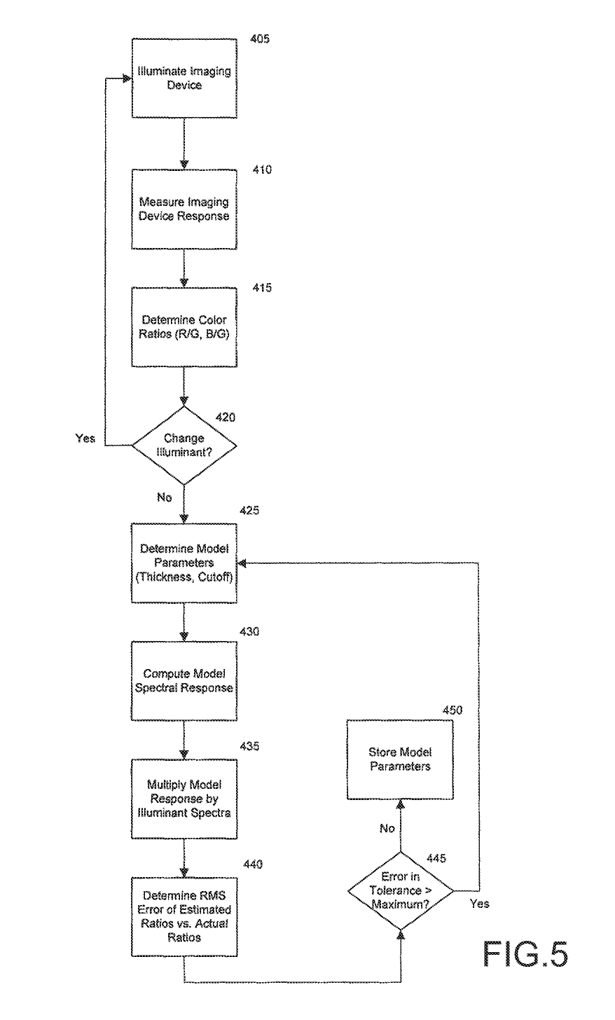

FIG. 5 is a sample flowchart depicting certain operations that may be performed to measure and capture certain channel responses that may be used in the estimation of the five parameters described above. Initially, the method 500 starts in operation 505, in which the imaging device 100 is illuminated by a light source having a known illuminant spectrum. Sample light sources may include narrow-band light sources, such as LEDs. Typically, multiple illuminants may be employed in the method of FIG. 4. Multiple illuminants may be necessary in order to accurately estimate each of the five spectral response parameters used to create the color correction matrix and/or neutral balance matrix (e.g., parameters λc, Tir, Tr, Tg, and Tb). Each measurement generally yields three values, namely color values for each of the red, green and blue channels. Because these values scale with illumination intensity, their intensity-independent ratios (e.g. R/G & B/G) are used to determine the model parameters.

Because each measurement provides only two independent values, three separate measurements under different illumination sources are generally performed in order to obtain sufficient data to solve Eq. 1, given above. This equation is a non-linear equation incorporating the five spectral response parameters. Thus, the illuminants are chosen to provide sufficient data to estimate each of the five spectral response parameters and solve the non-linear equation. Two measurements under different illuminations are necessary to obtain the relationship between each of the color response curves for the three color channels (since, for each measurement, one value is invariant). The third measurement generally is directed to determining the cutoff wavelength Inc of the IR absorptive filter. Accordingly, the illuminants are generally carefully chosen to maximize the embodiment's ability to determine these values.

Generally, the first illuminant (e.g., illumination source) is a high color temperature illuminant and the second illuminant is a low color temperature illuminant. As one non-limiting example, the first illuminant may be a D50 standard illuminant while the second is an A standard illuminant. That is, the first illuminant may represent an average incandescent light with attendant spectral power distribution; the spectral power generally increases as the wavelength of visible light increases. The second illuminant may have a correlated color temperature of approximately 5000° Kelvin, with an attendant spectral power distribution.

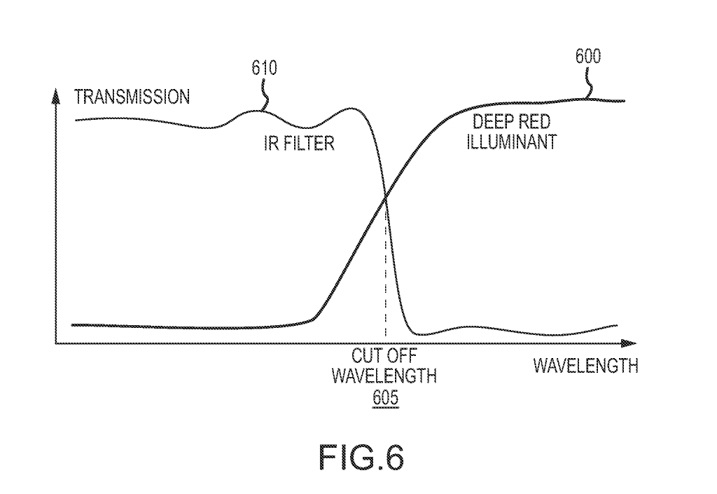

The third illuminant may be configured to have a strong change in transmission at or near an expected range of cutoff wavelengths for the IR absorption filter, as shown to best effect in FIG. 6. The wavelength 600 of the third illuminant rises relatively sharply from near zero to an arbitrary value around the cutoff wavelength Inc 605 of the IR filter. The transmission characteristic 610 of the IR filter is likewise shown in FIG. 6 to illustrate the transition between high transmissivity and low transmissivity at or near the cutoff wavelength 605. Unlike the various thicknesses, the embodiment generally attempts to measure and/or employ an actual value for the cutoff wavelength Inc 605 instead of a relative or scaled value.

It should be appreciated that the labels “first,” “second” and “third” are arbitrary. The illuminants may be chosen and used in operation 405 in any order. Accordingly, these labels are meant for convenience only. Further, the illuminants are chosen generally to enhance accuracy of estimated color ratios and IR cutoff points; although the illuminants may vary, in some embodiments it may be useful to have first and second illuminants that mirror light in typical operating environments for a digital imaging device. It should be appreciated that more than three illuminants may be used in certain embodiments.

Returning to FIG. 5, the imaging device's spectral response is measured in operation 410. The spectral response that is measured is dependent on the active illuminant.

Next, in operation 415, the embodiment determines a set of color ratios for the imaging device 100. Typically, although not necessarily, these are ratios of the red and blue channels to the green channel (e.g., R/G and B/G). In alternative embodiments, the color values in either the numerator or denominator of the ratios may be different. These ratios may also include a non-linear operator, such as logarithmic operators (e.g., (log R/log G) and (log B/log G)).

Once the color ratios are determined in operation 415, operation 420 is executed. In this operation, it is determined if the illuminant should be changed and operations 405-415 repeated for the imaging device 100. If so, the illuminant may be changed and operation 405 again executed with the new illuminant.

It should be noted that, when the illuminant is the third illuminant (e.g., the illuminant designed to reveal the cutoff wavelength of the IR absorptive filter), operation 415 may be replaced by variant operation 415b (not shown on the flowchart). In operation 415b, the embodiment analyzes the illuminant spectrum received by the image sensor 124. As the illuminant spectrum encompasses the IR wavelength cutoff 605 of the IR absorptive filter 310, wavelengths below the cutoff 605 will be recorded by the sensor 124 and those above the cutoff generally will not. In some embodiments, wavelengths slightly above the wavelength cutoff 605 may be recorded but will drop sharply off. Accordingly, the embodiment may relatively easily determine the cutoff wavelength 605 of the IR absorptive filter 310.

If all illuminants have been employed, the method proceeds to operation 425. In operation 425, the embodiment determines model parameters for the IR and color filter thicknesses, as well as the IR cutoff wavelength 605. As previously mentioned, the thicknesses may be expressed as scaling factors related to an arbitrary thickness corresponding to a model spectral response curve. The model parameters may be arbitrarily chosen in operation 425, may be selected based on the type of imaging device being subjected to the method of FIG. 5, may be chosen based on prior estimated values (for example, from prior iterations of this method), or through any other suitable process. Initial parameters may be chosen to match a manufacturer's specifications for an image sensor, IR filter, and/or lens, for example.

Following operation 425, operation 430 is executed. In this operation, the embodiment computes an estimated spectral response of an arbitrary imaging device, or an image sensor 124 of an imaging device 100, by solving Equation 1 using the model parameters determined in operation 425. This estimate is based on the model parameters and is not representative of the actual spectral response of the imaging device, but instead an adjusted spectral response. This yields estimated color ratios of red and blue to green, similar to those measured in operation 415.

In operation 435, the embodiment multiplies the model response by the illuminant spectra employed in operations 405-415, which permits the embodiments to determine color ratios for an imaging device having the model spectral response.

In operation 440, the embodiment determines the root mean square (RMS) error of the estimated ratios calculated in operation 430 against the actual color ratios determined in operation 415. The smaller the RMS error, the more accurate the model parameters from operation 425 are. In other embodiments, different error calculations may be used. For example, absolute error may be measured.

Next, operation 445 is executed. In this operation, the embodiment determines if the computed error, as determined in operation 440, is below a threshold. The threshold may be set by a user, programmer, manufacturer or the like. If the errors are under the threshold, then the model parameters are sufficiently close to the actual or ideal parameters of the imaging device. In this case, operation 450 is executed, the model parameters are stored in a digital memory or storage device and the method terminates. The parameters may be stored in a system memory, for example, and downloaded to one or more imaging devices during manufacture, quality control, calibration or other processes involving the devices. Alternately, the model parameters may be directly transmitted to the imaging device(s) and stored therein.

Otherwise, operation 425 is again executed and different model parameters are determined. The error determined in operation 440 may be used by the embodiment when selecting new model parameters in order to minimize error, and thus recursively refine the parameters.

It should be noted that the method of FIG. 5 presumes that the spectral responses of the various illuminants are known, and that the spatial relationship between the illuminants and any imaging device subjected to the method remains constant. For example, known illuminants may be set up adjacent one another and imaging devices may proceed down a conveyor belt, resting briefly beneath each illuminant in turn so that operations 405-415 may be performed sequentially for each illuminant. Insofar as known illuminants with known spectra are employed, there is no need to calculate or measure the illuminant spectra. Since most illuminants' spectral power distributions vary with age, it may be desirable to change the illuminants out for new or “fresh” illuminants at certain intervals or times. This may prevent or reduce the likelihood that aging will corrupt the illuminant spectral power distribution, which in turn would throw off the computed color ratios, model parameters and error estimation, all of which would ultimately result in inaccurate model parameters and thus incorrect color correction matrices. Alternatively, the spectral responses of the illuminants may be monitored or periodically measured; changes in the responses may be compensated for in the methodology.

If the spectral responses of the illuminants used in the method of FIG. 5 are not known, then they may be measured as part of the operations of FIG. 5. For example, they may be measured prior to operation 405 or operation 410.

Once the model parameters are determined (for example, through the method of FIG. 5), they may be transmitted to imaging devices 100 and stored in the devices' non-volatile memory. Given the relatively small size of these model spectral response parameters, they may be efficiently stored in a memory of a digital imaging device, such as a non-volatile memory, one example of which is firmware within the imaging device.

As images are captured by the imaging device 100, the stored spectral response (e.g., model) parameters may be used to adjust the white point, neutral balance and/or color balance of the captured image prior to displaying or storing that image, generally as part of image signal processing. The spectral response parameters may be retrieved from memory and a color correction matrix created on the fly as each image is captured. The color correction matrix may then be applied to the pixel data of the image to create a balanced image. Typically, the matrix is applied on a pixel-by-pixel basis. These model parameters may be employed to color correct any image captured by the digital imaging device 100, regardless of the device's environment, as they describe a baseline spectral response. In some embodiments, additional image processing may be employed to account for environmental effects and/or conditions.

In some embodiments, the image data is adjusted prior to being stored; the adjusted image data is then stored in the device's memory 134. In other embodiments, the captured image data may be stored and the color correction matrix applied every time the image data is retrieved.

Conclusion

The foregoing description has broad application. For example, while examples disclosed herein may give examples of utilizing a smart phone or mobile computing device as an imaging device, it should be appreciated that the concepts disclosed herein may equally apply to other image capturing devices and light sources. Similarly, the particular method for creating and applying spectral response parameters to generate a color correction matrix may vary between embodiments. The embodiments disclosed herein may be used not only for imaging sensors, but also for ambient light sensors, metering sensors, and other types of light and/or optical sensors. Further, it should be appreciated that certain embodiments may omit some parameters, such as those associated with the infrared filter, if the corresponding filter is not present. Continuing that example, an ambient light sensor may lack an infrared filter; the methodology described herein may be adjusted to obtain a spectral response for the light sensor in the absence of the infrared filter by omitting the parameters associated with that filter.

Accordingly, the discussion of any embodiment is meant only to be an example and is not intended to suggest that the scope of the disclosure, including the claims, is limited to any examples set forth herein.

We claim:

1. A method for determining color correction parameters for a digital imaging device, comprising:
estimating a set of model parameters;
determining a spectral response corresponding to the set of model parameters;
determining a set of estimated color ratios corresponding to the set of model parameters for a particular illuminant;
calculating an error of the set of estimated color ratios with respect to a set of measured color ratios; and
in the event the error is below a threshold, storing the set of model parameters in the digital imaging device.

2. The method of claim 1, further comprising:
in the event the error is not below the threshold, employing the error to estimate a second set of model parameters.

3. The method of claim 1, wherein the set of model parameters comprises:
an infrared filter thickness;
a infrared filter cutoff; and
one or more color filter thicknesses.

4. The method of claim 3, wherein:
the infrared filter thickness comprises an infrared absorptive filter thickness; and
the infrared filter cutoff comprises an infrared interference filter cutoff.

5. The method of claim 1, further comprising:
illuminating a target with at least three separate illuminants; and
calculating the set of measured color ratios from the target, while the target is illuminated.

6. The method of claim 5, further comprising estimating a spectral response corresponding to each of the at least three separate illuminants.

7. The method of claim 6, wherein:
the first illuminant is a high color temperature illuminant; and
the second illuminant is a low color temperature illuminant.

8. The method of claim 7, wherein:
the first illuminant is a D50 standard illuminant; and
the second is an A standard illuminant.

9. The method of claim 6, wherein the illuminant is produced by a narrow-band light source.

10. The method of claim 8, wherein the third illuminant is configured to have a strong change in transmission at or near an expected range of cutoff wavelengths for an IR absorption filter of the digital imaging device.

11. The method of claim 1, wherein the operation of determining a set of estimated color ratios corresponding to the set of model parameters comprises:
multiplying the spectral response by a spectral illumination profile of an illuminant.

12. The method of claim 1, wherein the operation of calculating an error of the set of estimated color ratios with respect to a set of measured color ratios comprises calculating a root mean square error of the set of estimated color ratios with respect to a set of measured color ratios.

13. The method of claim 1, wherein the model parameters are expressed as scaling factors related to an arbitrary filter thickness and corresponding to a model spectral response curve

14. A method for creating a digital image, comprising:
capturing, by a digital imaging device, a digital image;
retrieving a set of model parameters from a storage medium of the digital imaging device;
creating a color correction matrix from the set of model parameters; and
applying the color correction matrix to the digital image, thereby generating a color-corrected digital image.

15. The method of claim 14, further comprising storing the digital image in a storage medium of the digital imaging device prior to applying the color correction matrix.

16. The method of claim 14, further comprising storing the color-corrected digital image in a storage medium of the digital imaging device.

17. The method of claim 14, wherein the set of model parameters comprises:
an infrared filter thickness;
a infrared filter cutoff; and
one or more color filter thicknesses.

18. The method of claim 17, wherein:
the set of model parameters is estimated during a calibration process of the digital imaging device; and
the set of model parameters is applied without reference to an environment of the digital imaging device.

19. The method of claim 17, wherein the color correction matrix is employed to neutral balance the digital image.

20. The method of claim 18, wherein the color correction matrix is employed to color balance the digital image.

21. A digital imaging device, comprising:
a lens;
a digital imaging sensor in optical communication with the lens;
an infrared filter positioned such that light passing through the lens and impinging upon the sensor passes through the infrared filter;
a color filter adjacent the digital imaging sensor;
a processor operative to receive digital imaging data captured by the digital imaging sensor; and
a storage medium in communication with the processor and operative to store a set of model parameters; wherein
the processor is operative to retrieve the set of model parameters, construct a color correction matrix from the model parameters, and employ the color correction matrix to adjust the digital imaging data.
